(19) United States
(12) Patent Application Publication
(10) Pub. No.: US 2018/0304516 A1
(43) Pub. Date: Oct. 25, 2018

(54) SINGLE USE CONTAINER WITH AN INTEGRATED DECORATIVE PATTERN

(71) Applicant: First Quality Packaging Solutions, LLC, Great Neck, NY (US)

(72) Inventor: Mark Strachan, Jupiter, FL (US)

(21) Appl. No.: 15/959,792

(22) Filed: Apr. 23, 2018

Related U.S. Application Data
(60) Provisional application No. 62/488,996, filed on Apr. 24, 2017.

(51) Int. Cl. B29C 47/10; B65D 1/26; B65D 1/28; B29C 47/00; B29C 47/06; B29C 47/56; B29C 51/14; B29C 51/08

(52) U.S. Cl. CPC B29C 47/10; B65D 1/265; B65D 1/28; B29C 47/0054; B29L 2031/7132; B29C 47/0021; B29C 47/56; B29C 51/14; B29C 51/082; B29C 47/065

(57) ABSTRACT

A single use container having integrated intertwining patterns on one or more of an outer surface and an inner surface. A method of forming a single use container having integrated intertwining patterns that includes extruding a polymer material, injecting a plurality of colors at respective predetermined locations of the extruded flow of polymer material, agitating the extruded flow with the injected colors, extruding the agitated flow into a flat sheet, and molding the flat sheet to a shape of the single use container.

### CROSS-REFERENCE TO RELATED APPLICATIONS

This application claims the benefit of and priority to U.S. Provisional Patent Application Ser. No. 62/488,996, filed Apr. 24, 2017, the entire contents of which is incorporated by reference herein.

### BACKGROUND OF THE INVENTION

Single use containers, such as disposable cups, bottled water or beverage containers, and the like, have been ubiquitous in the beverage industry. For bottled water, the containers have been made with glass or clear plastic, and product information and/or decorative features or logos are usually added on a label or a sleeve covering all or parts of the bottles. Disposable cups have been made with paper, polystyrene (“PS”) (e.g., Styrofoam™ cups), and polypropylene (“PP”). Polystyrene foam cups are usually white without any colored ornamentation. Paper cups may include printed patterns on the outside of the cup and plastic polypropylene cups are usually single colored with an opaque white interior or transparent.

### SUMMARY OF THE INVENTION

As discussed above, disposable single use containers are generally either transparent or opaque with single colors, where any distinct ornamentation would require the addition of a printed label/sleeve or, in the case of paper cups, printing on the exterior of the containers.

An object of the present invention is to provide single use containers having integrated decorative patterns, which may include multiple respective characteristics, such as pigmentation, translucency, gloss, and surface texture. For example, the integrated decorative patterns may include multiple colors that are either opaque, translucent, or varying degrees thereof.

Another object of the present invention is to provide an efficient process for manufacturing single use containers having the integrated decorative patterns.

According to an exemplary embodiment of the invention, a container, such as a single use cup, may comprise: one or more first layers of a first polymer material having a first pigmentation, the first pigmentation comprising a pigmentation type selected from the group consisting of Phthalocynanine Green, Phthalocynanine Blue, Benzimidazolone Yellow or Orange, Alizarine Maroons, Titanium Dioxide White, Permanent Red 2B, and Carbon Black; and one or more second layers of a second polymer material having a second pigmentation, the second pigmentation being different from the first pigmentation and comprising a pigmentation type selected from the group; wherein at least one of the first layers and at least one of the second layers are intertwined with each other on one or more of an outer surface and an inner surface of the single use container. In embodiments, the first polymer material and the second polymer material may be the same polypropylene material, each with a different color pigment, or may be a HIPS (High Impact Polystyrene), or APET (Amorphous Polethylene Terephthalate) or HDPE—(High Density Polyethylene) polymer. Other material layers, such as EVOH (Ethylene Vinyl Alcohol), may also be added to any of the above mentioned materials to prevent oxygen ingress into a package.

In an embodiment, the intertwined at least one first layer and at least one second layer form one or more anisotropic pattern features on the one or more of the outer surface and the inner surface of the container.

In an embodiment, the intertwined at least one first layer and at least one second layer form a pseudo-random pattern on the one or more of the outer surface and the inner surface of the container.

In an embodiment, the single use container comprises the intertwined at least one first layer and at least one second layer on the outer surface and further comprises a single color layer on the inner surface.

In an embodiment, the single color layer is an opaque white layer.

In an embodiment, the single use container has a base and side walls wherein the base and side walls are substantially made from polypropylene or other polymer types. In an embodiment, the side walls have a thickness of about 0.05″ to 0.1″. In an embodiment, the single use container comprises a substantially cylindrical side wall. In an embodiment, the single use container is manufactured from a polypropylene sheet having a thickness greater than 0.08″. In an embodiment, the single use container is manufactured from a polypropylene sheet having a thickness less than 0.08″. In an embodiment, the single use container is thermoformed over a cooled mold, cooled relative to the polypropylene being thermoformed.

In an embodiment, a single use container comprises a base and one or more side walls that are formed from a plurality of layers of material substantially comprising polypropylene, wherein the plurality of layers of material each comprises a different respective characteristic from at least one other layer of material, the characteristic being selected from the group consisting of pigmentation, translucency, gloss, and surface texture, and wherein at least two of the plurality of layers of material overlap each other on one or more of an inner surface and an outer surface of the one or more side walls.

In an embodiment, the at least two of the plurality of layers of material overlap each other to form one or more isotropic pattern features on the one or more of the inner surface and the outer surface of the one or more side walls.

In an embodiment, the at least two of the plurality of layers of material overlap each other to form a pseudo-random pattern on the one or more of the inner surface and the outer surface of the one or more side walls.

In an embodiment, the at least two of the plurality of layers of material overlap each other on the outer surface of the one or more side walls and a single color layer is disposed on the inner surface of the one or more side walls.

In an embodiment, the single color layer is an opaque white layer.

According to an exemplary embodiment of the invention, a process for manufacturing a single use container may include the steps of providing a laminar flow having at least one or more first layers and one or more second layers with differing compositions, agitating the laminar flow, and extruding the agitated flow in a flat sheet extrusion process, thus intertwining at least one of the first layers and at least one of the second layers and forming varying patterns in the extruded flat sheet. The flat sheet with intertwined layers may then be formed into a container, such as a single use cup.

In an embodiment, the step of providing a laminar flow having at least one or more first layers and one or more second layers with differing compositions is performed by combining at least a first and a second polymer flow prior to the agitating.

In an embodiment, the step of providing a laminar flow having at least one or more first layers and one or more second layers with differing compositions is performed by injecting at least one additive material into a portion of a polymer flow so as to form a first layer that differs in composition from the rest of the polymer flow.

In an embodiment, the differing compositions include the same substrate material but differ in terms of additives. The additives can alter the visual properties of the extruded sheet such as color, transparency, reflectance, and texture.

In an embodiment, the step of agitating is performed in an agitation chamber that is downstream from the combining of the at least first and second polymer flows.

According to another exemplary embodiment of the invention, a method for forming a single use container that incorporates one or more pattern features on one or more of an outer surface and an inner surface, may comprise: extruding a first polymer material to form a first flow of the first polymer material; injecting a plurality of pigments at respective predetermined locations to the first flow of the first polymer material; agitating the first flow of the first polymer material; extruding the agitated flow of the first polymer material through a flat sheet die; and molding the extruded first polymer material from the flat sheet die to a predetermined shape of the single use container.

In an embodiment, the method for forming a single use container may further comprise: extruding a second polymer material to form a second flow of the second polymer material; and combining the second flow of the second polymer material with the agitated flow of the first polymer material prior to the extruding through the flat sheet die.

In an embodiment, the injecting comprises one or more of continuous and intermittent injections of the respective pigments.

In an embodiment, the injecting comprises a plurality of different injection rates for the respective pigments.

In an embodiment, the agitating is performed by a static mixer of a predetermined length.

In an embodiment, the first flow of the first polymer material is agitated prior to the injecting of the plurality of pigments.

### BRIEF DESCRIPTION OF DRAWINGS

FIG. 1 is a side view schematic diagram showing a sheet extrusion process for forming a flat sheet precursor to a plastic cup.

FIGS. 2A and 2B are top and side views, respectively, of an extrusion system for extruding flat sheets with multiple layers.

FIG. 3 is a top view schematic diagram illustrating an example of a process for forming standard single color (red) plastic disposable cups.

FIGS. 4A-4C are diagrams illustrating examples of an agitator for use in an extrusion system to impart an integrated pattern to a single use plastic container embodying exemplary features of the invention.

FIGS. 5A-5D are schematic diagrams showing extrusion processes incorporating one or more agitators, as illustrated in FIGS. 4A-4C, in exemplary embodiments of the invention.

FIGS. 6A-6G are diagrams showing a thermoforming process for forming patterned disposable plastic cups embodying exemplary features of the invention from an extruded flat sheet produced as illustrated in FIGS. 5A-5C in accordance with an exemplary embodiment of the invention.

FIGS. 7A-H show side view diagrams of example flat sheet layer combinations for selective agitation to form patterns embodying particular exemplary features of the invention for a plastic single use container.

FIGS. 8A and 8B are side and perspective view diagrams showing a patterned disposable plastic cup according to an exemplary embodiment of the invention.

FIGS. 8C and 8D are perspective and top view diagrams illustrating an alternate patterned disposable plastic cup to the cup shown in FIGS. 8A and 8B according to another exemplary embodiment of the invention.

FIGS. 9A and 9B are side and perspective view diagrams showing another patterned disposable plastic cup according to another exemplary embodiment of the invention.

FIGS. 9C and 9D are perspective and top view diagrams illustrating another alternate patterned disposable plastic cup to the cup shown in FIGS. 9A and 9B according to another exemplary embodiment of the invention.

FIG. 10 is a schematic diagram illustrating an extrusion system incorporating a color injection and agitation device according to an exemplary embodiment of the invention to impart an integrated pattern to a single use plastic container embodying exemplary features of the invention.

FIG. 11A is an external view of the color injection and agitation device illustrated in FIG. 10 in accordance with an exemplary embodiment of the invention.

FIGS. 11B and 11C are respective cross-sectional and exploded side views of the color injection and agitation device illustrated in FIG. 10 in accordance with an exemplary embodiment of the invention.

FIGS. 11D and 11E are perspective and side cross-sectional views of the color injection and agitation device illustrated in FIG. 10 in accordance with an exemplary embodiment of the invention.

FIG. 11F is a side cross-sectional view of the color injection and agitation device according to an alternative embodiment of the invention.

FIG. 12 illustrates respective alternative internal static mixers of the color injection and agitation device illustrated in FIG. 10 in accordance with exemplary embodiments of the invention.

FIGS. 13A-B are diagrams illustrating color mixture patterns resulting from internal static mixers of various dimensions in the color injection and agitation device illustrated in FIG. 10 in accordance with exemplary embodiments of the invention.

### DETAILED DESCRIPTION OF THE INVENTION

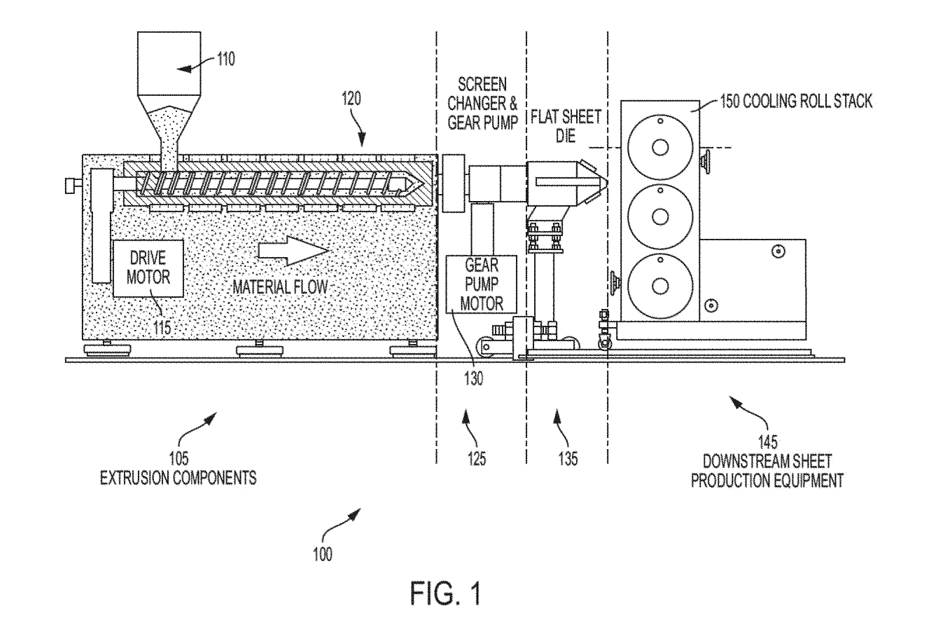

FIG. 1 illustrates a sheet extrusion process for forming a flat sheet precursor to a single use container, such as a plastic (e.g., PP) cup. As shown in FIG. 1, an extrusion system 100 may include extrusion components 105 that comprise a material hopper 110 for receiving plastic raw materials—such as PP, HIPS, APET, PETG (Polyethylene terephthalate glycol-modified), HDPE, and the like—and a drive motor 115 that drives, for example, a rotating screw for moving the received materials through a heated barrel 120 for heating and melting the plastic raw materials. The extrusion proceeds to a screen changer and gear pump 125 driven by a gear pump motor 130 for pumping the material through a flat sheet die 135. The extruded plastic flat sheet proceeds downstream to sheet production equipment 145 through a cooling mechanism 150, such as a cooling roll stack.

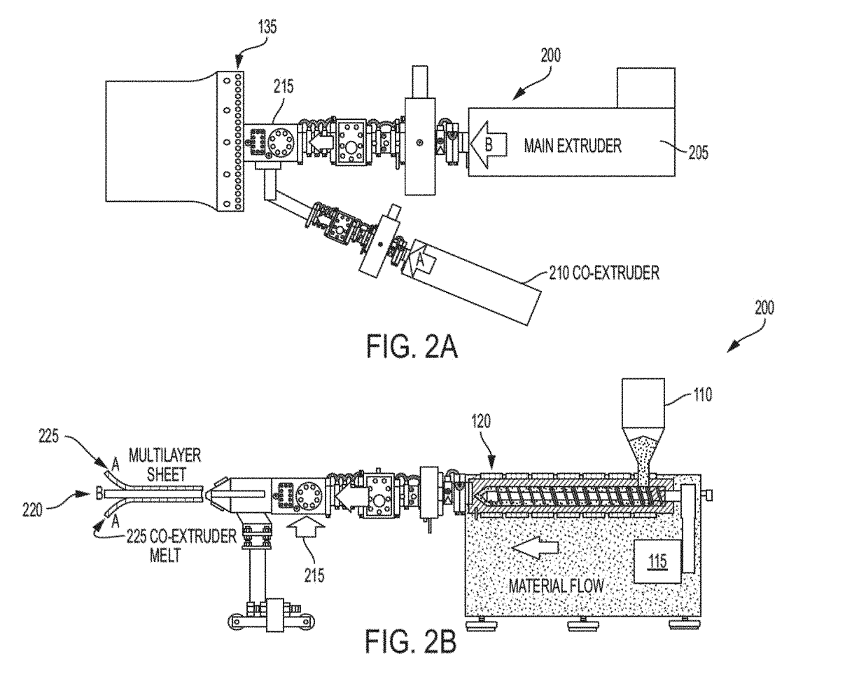

FIGS. 2A and 2B are top and side views, respectively, of an extrusion system 200 for extruding flat sheets with multiple layers. As shown in FIG. 2A, system 200 comprises a main extruder 205 and a co-extruder 210 that each may comprise corresponding elements of an extrusion system 100 shown in FIG. 1. The outputs of these extruders 205 and 210 may be incorporated together through a feedblock 215 to the flat sheet die 135 such that a main interior layer 220 is disposed between two exterior co-extruder layers 225. The function of the feedblock 215 is to accurately combine polymer melt streams from one, two, or more co-extruders—for example, co-extruder 210—with a main extruder (205) melt stream before it enters an extrusion die, such as flat sheet die 135. The melted polymer from co-extruder 210—and any additional co-extruders—is layered down onto the melt flow of main extruder 205.

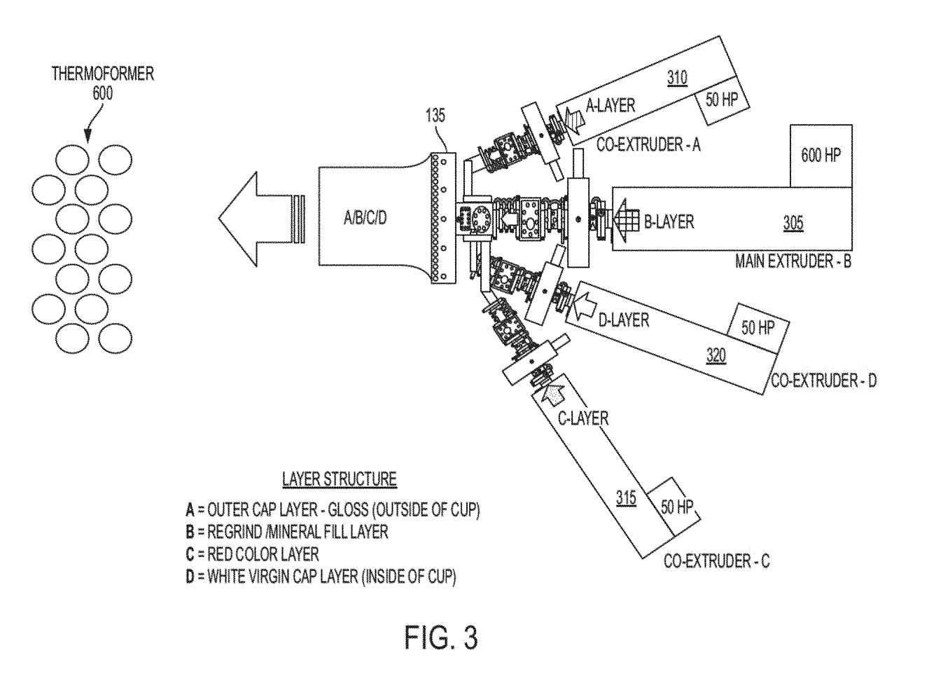

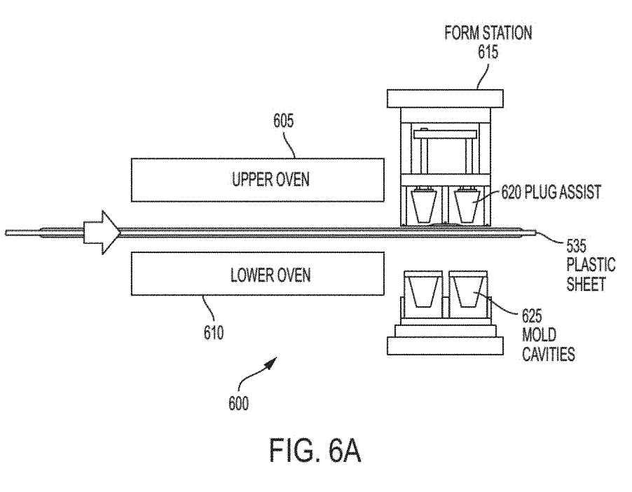

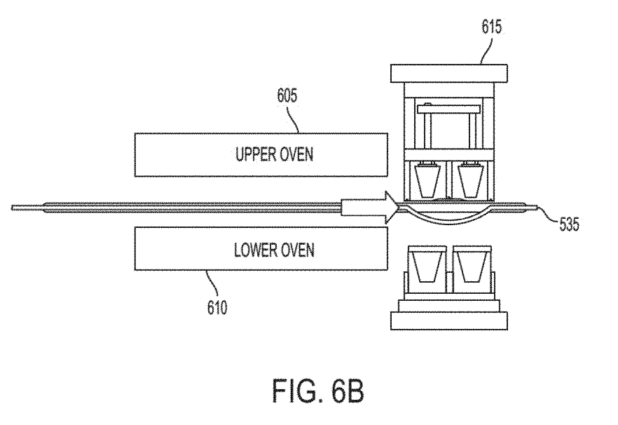

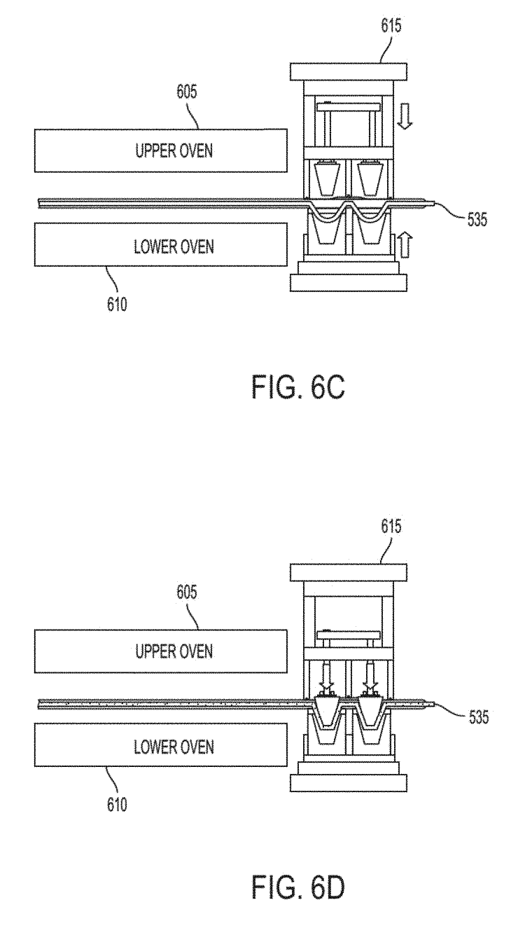

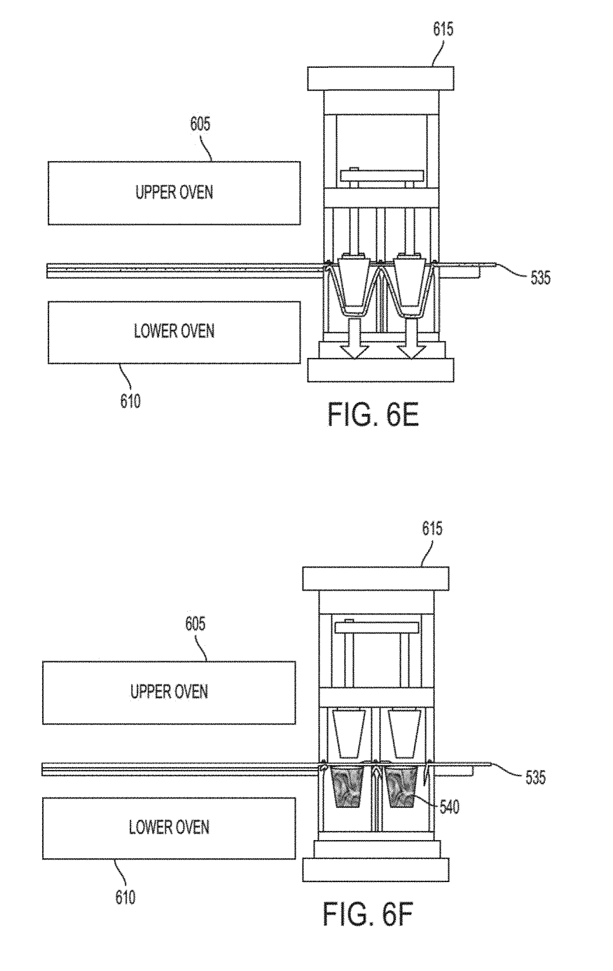

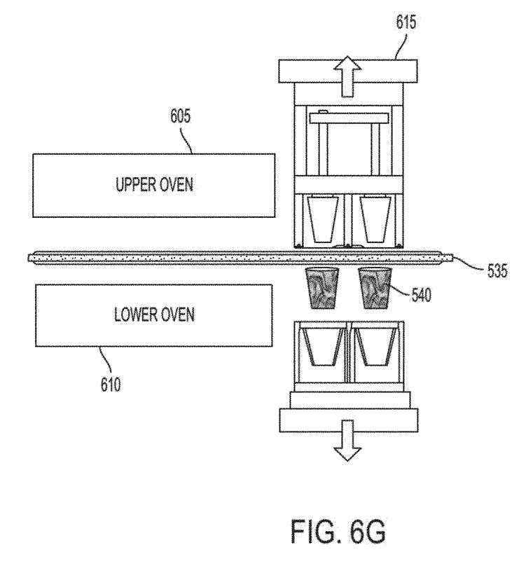

FIG. 3 illustrates an example of a process for forming single color (red) PP disposable cups. As shown in FIG. 3, four (4) layers may be co-extruded, from four respective extruders 305, 310, 315, and 320, to form respective layers that include: (A) an outer cap layer with a glossy material for the outside of the cups; (B) a main regrind/mineral fill layer comprising the principal physical material for the bodies of the cups; (C) a color—e.g., red—layer; and (D) a white virgin cap layer for providing a white interior to the cups. The extruded flat sheet may be provided downstream to sheet production equipment 145 (as shown in FIG. 1), with a thermoformer 600 for forming the shapes of the cups from the layered flat sheet, as illustrated in FIG. 3. An example for thermoforming the cups, and thermoformer 600, will be described in further detail below with reference to FIGS. 6A-6G.

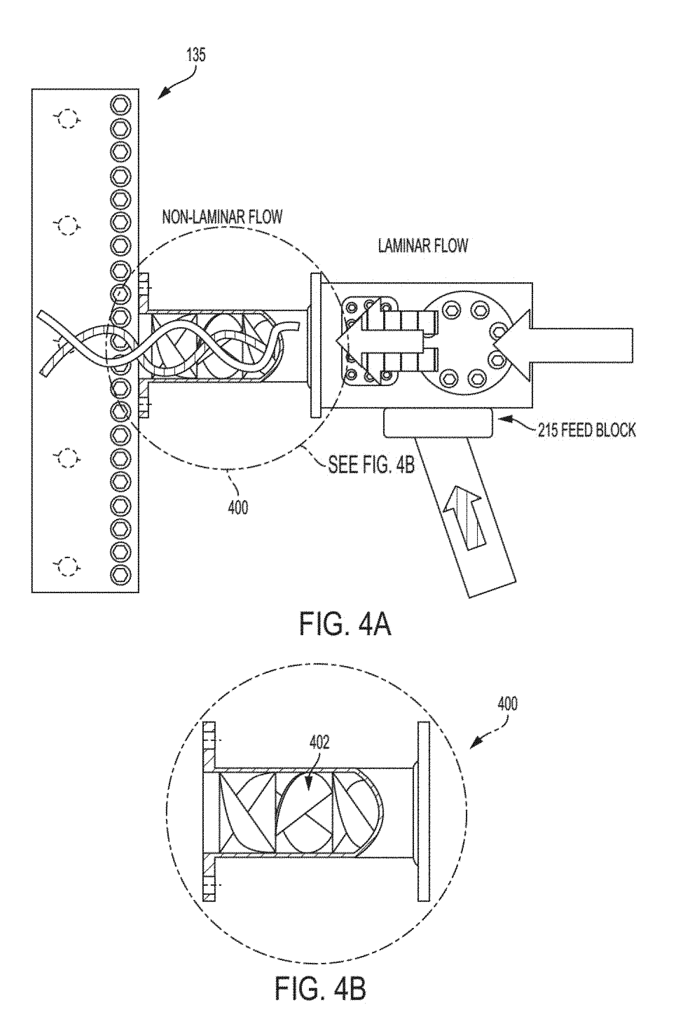

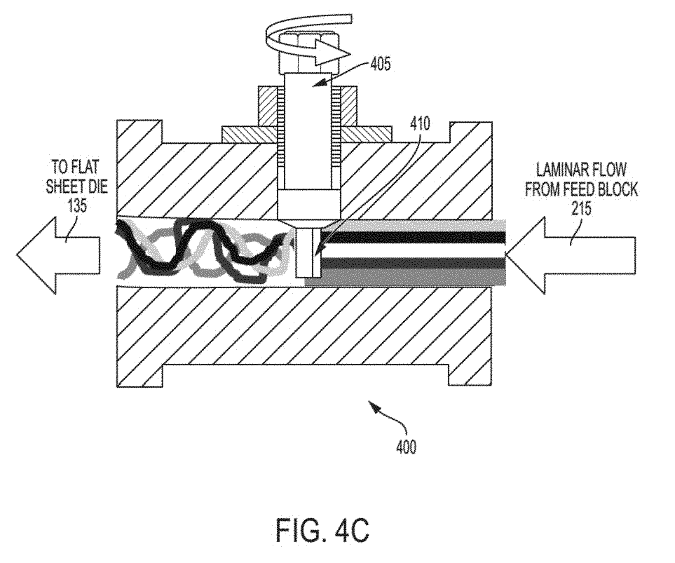

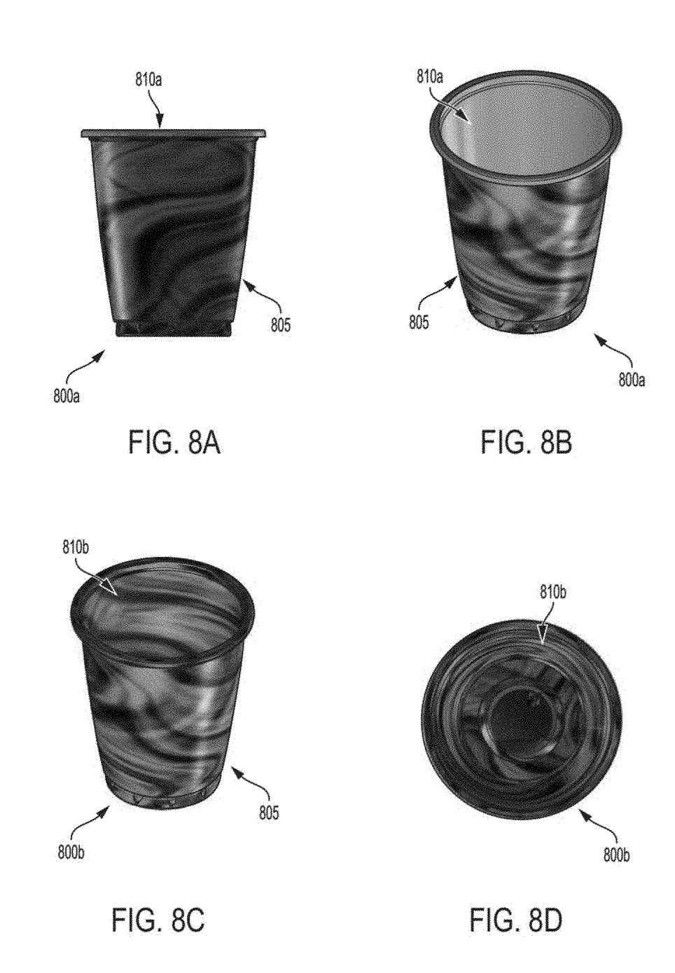

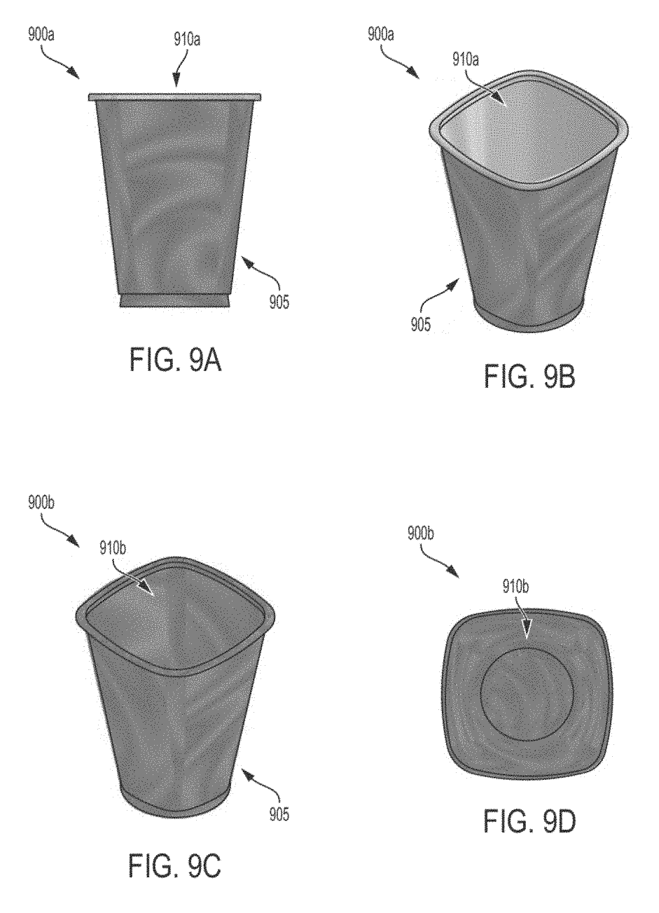

FIG. 4A and FIG. 4B are diagrams illustrating an agitator 400 for use in an extrusion system for imparting varying patterns to a flat sheet precursor to a single use plastic container according to an exemplary embodiment of the present invention. U.S. Pat. No. 3,422,175 describes a method for extruding thermoplastic sheet material using an agitator to impart a pattern in the extruded material. As shown in FIG. 4A, agitator 400 may be incorporated between feedblock 215 and flat sheet die 135, for example, in an extrusion system such as system 200 shown in FIGS. 2A and 2B. As illustrated in FIG. 4B, agitator 400 may incorporate plural movable surfaces 402 for agitating, disrupting, and intermixing multiple molten polymer layers to form intertwining patterns. FIG. 4C illustrates another embodiment of agitator 400. As shown in FIG. 4C, agitator 400 may comprise a shaft 405 for rotating an agitation member 410, which may be a paddle or other agitating device. Shaft 405 may be motorized or coupled to a manual dial. As further illustrated in FIGS. 4A and 4C, the laminar flow from feedblock 215 is disrupted and intermixed so that polymer layers that differ in one or more characteristics, including pigmentation, translucency, gloss, and the like, may be intertwined with one another to form a pattern when a flat sheet is extruded from flat sheet die 135. According to an embodiment of the invention, a pseudo-random pattern may be formed in an extruded flat sheet and, correspondingly, a single use container formed from the extruded flat sheet. FIGS. 4A and 4C illustrate intermixing three (3) and five (5) layers of different polymer melts but any number of at least two (2) layers may be intermixed to form a patterned single use container. In an exemplary embodiment, the disrupted laminar feed may be introduced into a second feedblock where one or more additional layers may be extruded on one or both sides of the disrupted laminar feed (for example, for forming an opaque white layer on an interior of a cup, as described below in correspondence with FIGS. 8A, 8B, 9A, and 9B).

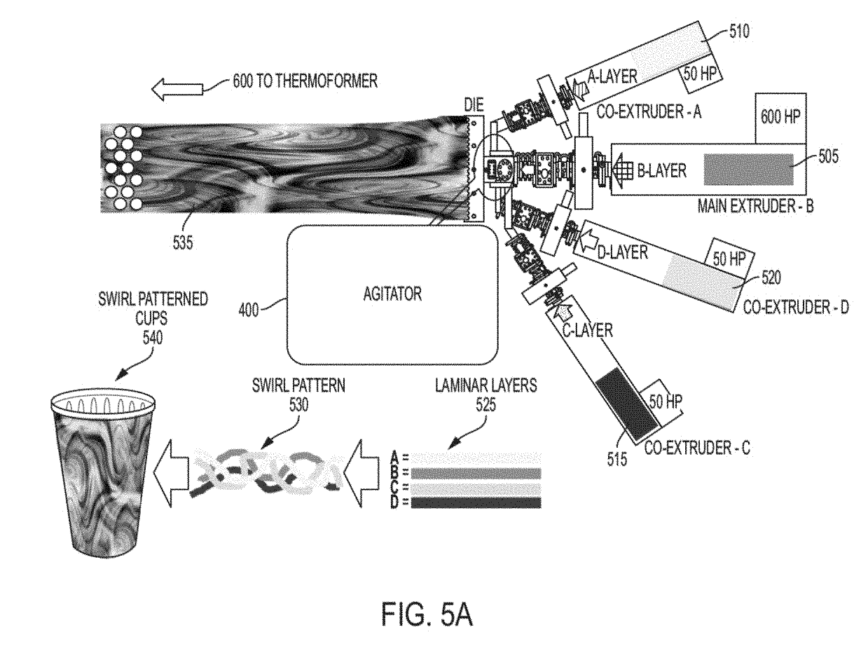

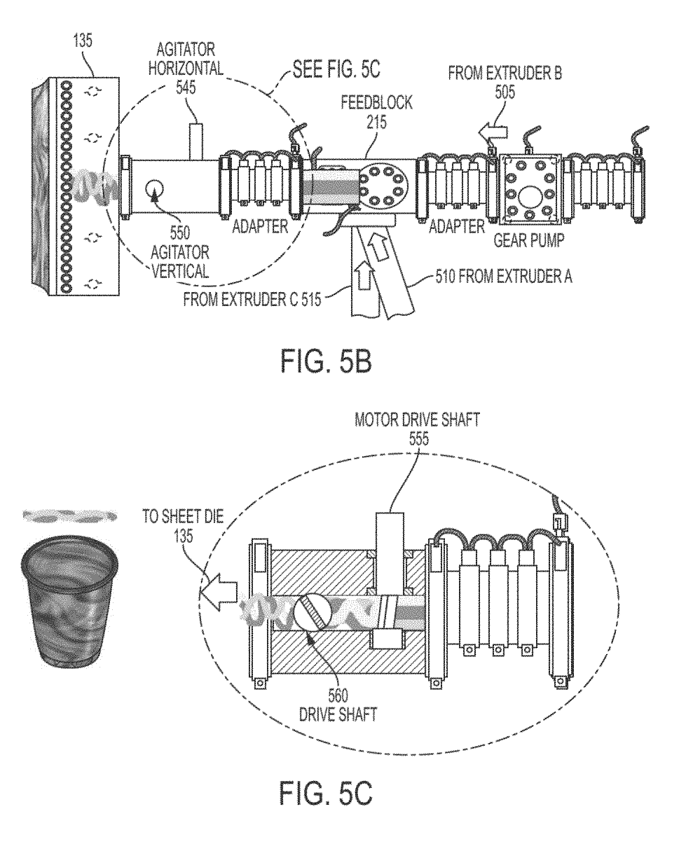

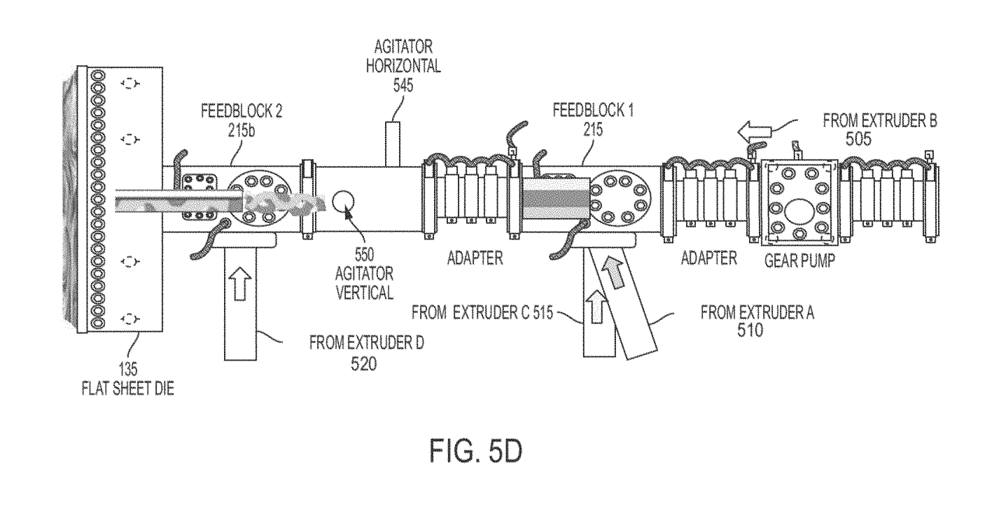

FIG. 5A illustrates an exemplary embodiment of an extrusion system incorporating agitator 400. As shown in FIG. 5A, extruders 505, 510, 515, and 520 may be used to form respective laminar flow A, B, C, and D that are incorporated with one another in a layered fashion to form laminar layers 525—by, for example, feedblock 215 as described above—and agitator 400 may be disposed between feedblock 215 and flat sheet die 135 to disrupt the layered laminar flow to form swirl pattern 530, which is then fed through flat sheet die 135 to form a patterned flat sheet 535. The patterned flat sheet 535 is then fed to a thermoformer 600 for forming swirl patterned cups 540, as described in further detail below.

FIGS. 5B, 5C, and 5D illustrate respective exemplary embodiments of an extrusion system for a cup devoid of an opaque interior layer (FIGS. 5B and 5C), as illustrated in FIGS. 8C and 8D and an extrusion system for a cup including an opaque interior layer (FIG. 5D), as illustrated in FIGS. 8A and 8B. As illustrated in FIGS. 5B and 5C, an extrusion system according to the invention may comprise more than one agitator—for example, two agitators, such as a horizontal agitator 545 and vertical agitator 550, comprising respective agitation elements, such as drive shafts 555 and 560, that are arranged orthogonally (or any angle) in relation to one another. As further illustrated in FIG. 5D, an additional feedblock 215b may be incorporated downstream from the laminar flow agitation—for example, by agitators 545 and 550 on flows from extruders 505, 510, and 515 that are combined at feedblock 215, as described above—in order to add an opaque interior layer—for example, from extruder 520—to the resulting cup.

FIGS. 6A-6G are diagrams illustrating a thermoforming process using a thermoforming assembly (or thermoformer) 600 for forming swirl patterned cups 540 from a patterned flat sheet 535 according to an exemplary embodiment of the present invention. As shown in FIG. 6A, flat sheet 535 may be fed through a heater comprising an upper oven 605 and a lower oven 610. According to an exemplary embodiment of the invention, plastic flat sheet 535 may be heated to a temperature of approximately 250° F. or above (e.g., 300° F.). As shown in FIG. 6B, the heated flat sheet 535 is then indexed into a form station 615 comprising corresponding plug assists 620 and mold cavities 625 (FIG. 6A). The upper (620 in FIG. 6A) and lower (625 in FIG. 6A) mold halves are then moved together to clamp the heated flat sheet 535, as shown in FIGS. 6C and 6D. Next, as shown in FIG. 6E, a vacuum and/or an air pressure controller (not shown) may be activated to push the flat sheet 535 against mold cavities 625. In accordance with an exemplary embodiment of the invention, the mold cavities 625 may be maintained at a temperature below 100° F. (e.g., 80° F.). Thus, as illustrated in FIG. 6F, plug assists 620 may be retracted while flat sheet 535, now pressed against mold cavities 625, may cool against the surfaces of the mold cavities 625. The flat sheet 535, with shapes of cups 540 now pressed therein, is then fed out of form station 615 so that cups 540 may be trimmed out, as illustrated in FIG. 6G.

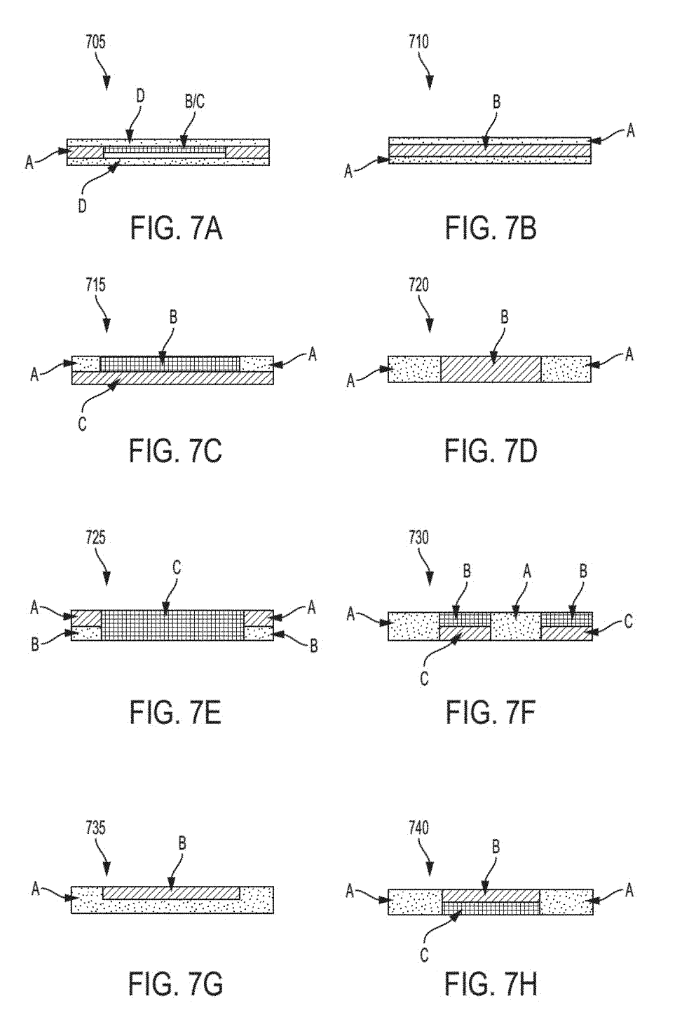

According to exemplary embodiments of the invention, laminar layers A-D 525 shown in FIG. 5A may be combined in different layered and/or side-by-side configurations through feedblock 215. FIGS. 7A-H show respective examples 705, 710, 715, 720, 725, 730, 735, and 740 of laminar melt flows (materials) A, B, C, and D arranged in different configurations by, for example, feedblock 215, which may then be agitated at predetermined locations relative to the respective arrangements to form different patterns having characteristics that reflect particular features of the invention with respect to the outward appearance of a resulting cup 540, on its outer surface and/or its inner surface. As shown in FIGS. 7A-H, the respective materials A, B, C, and D, each incorporating respective characteristics, such as pigmentation, translucency, gloss, and surface texture, may be arranged in layers over one or more portions of the overall laminar flow and one or more of the materials may span more than one layer of other materials in adjacent portions of the overall flow (e.g., material C adjacent layers A and B in arrangement 725 and material A adjacent layers B and C in arrangement 730, etc.).

In an exemplary embodiment of the invention, the cup 540 may include an external layer made from at least two polymer compositions (e.g., forming respective materials A, B, C, and D shown in FIGS. 7A-H), the at least two polymer compositions differing in at least one of tint, color intensity, translucency, fluorescence and reflectance. In some embodiments, one of the at least two polymer compositions may include embedded objects, such as glitter or colored beads. The cup 540 may include an internal layer—formed, for example, via feedblock 215b and extruder 520 shown in FIG. 5D—made from a single polymer composition wherein the internal layer meets one or more food safety standards. In some embodiments the internal layer may be substantially clear or may be a solid color, including white. In some embodiments, the inner layer may be a two layer structure with the innermost layer providing a food safe surface and the underlying layer being substantially opaque and solid colored. In some embodiments, the external layer may have a textured surface. The textured surface may be on the entire exterior of the cup or may be limited to areas where one or more of the at least two polymer compositions are part of the surface of the external layer. In some embodiments, the textured surface permits cup 540 to be arranged in a nested configuration. In some embodiments, one or more of the visual elements of the external layer of the cup 540 may be anisotropic. In some embodiments, the anisotropy of the visual elements of the external layer of the cup 540 may provide an appearance of increased size to an observer without presenting a repeating arrangement of visual elements.

In embodiments, one or more layers may include particulates, such as glitter. In some embodiments the particulates may be distributed substantially uniformly. In other embodiments, the particulates may be restricted to one or more layers and may be substantially non-uniformly distributed. In some embodiments, the particulates may be included within a pigmented layer and may have a coloration that differs from the pigmented layer.

In embodiments, one or more layers may include a temperature sensitive pigment. In some embodiments, a layer including a temperature sensitive pigment may be substantially the same color as a layer that does not include the temperature sensitive pigment when the temperature of the cup is above a designated threshold value but changes to a different color when the temperature of the cup is below the threshold value.

FIGS. 8A and 8B are side and perspective view diagrams showing a patterned disposable plastic cup 800a according to an exemplary embodiment of the invention. As shown in FIGS. 8A and 8B, the plastic cup 800a may comprise an exterior 805 having a swirl pattern (e.g., swirl pattern 530) resulting from the above-described laminar flow agitation process. According to an exemplary embodiment of the invention, the cup 800a may have a height of approximately 5″, an interior rim circumference of approximately 4″, and an interior base circumference of approximately 2.5″. The body of cup 800a (e.g., between the rim and the base) may have an average thickness of approximately 0.040″, with an average thickness of each colored layer being approximately 0.015″. The swirl pattern on the exterior 805 of cup 800a may comprise a mixture of two, three, or more distinct colors (for example, Phthalocynanine Green, Phthalocynanine Blue, Benzimidazolone Yellow or Orange, Alizarine Maroons, Titanium Dioxide White, Permanent Red 2B, and the like) having approximately proportional coverage on the exterior 805. According to embodiments of the invention, as reflected by the respective arrangements in FIGS. 7A-H, respective colors may have different surface coverage percentages on exterior 805. The respective layers (colors) forming the swirl pattern may be transparent, have the same or respective degrees of translucency, or opaque. According to an exemplary embodiment of the invention, cup 800a may comprise an opaque interior 810a having, for example, a white color (e.g., Titanium Dioxide), the opaque interior 810a providing a backdrop to the transparent/translucent layers forming the swirl pattern on the exterior 805. As an example, a resulting contrast range on exterior 805 may be between approximately 10% to 50%. Exterior 805 of cup 800a may be smooth, patterned with, say, one or more ridges, or may comprise one or more textures corresponding to additives for the respective color layers.

FIGS. 8C and 8D are perspective and top view diagrams illustrating an alternate patterned disposable plastic cup to the cup shown in FIGS. 8A and 8B according to an exemplary embodiment of the invention. As shown in FIGS. 8C and 8D, plastic cup 800b may comprise an exterior 805 having a swirl pattern (e.g., swirl pattern 530) resulting from the above-described laminar flow agitation process. According to an exemplary embodiment of the invention, cup 800b may be similarly dimensioned as cup 800a with a corresponding patterned exterior 805. However, cup 800b may comprise an interior 810b devoid of an opaque layer. In other words, a swirl pattern, which may correspond to the pattern on exterior 805 dependent upon the transparency and translucency of the respective swirl pattern layers, is visible on the interior 810b of the cup 800b, as shown in FIGS. 8C and 8D. As an example, a resulting contrast range on the exterior 805 may be between approximately 10% to 80%. Cup 800b may also have an average body thickness of approximately 0.040″ without the opaque interior layer.

FIGS. 9A and 9B are side and perspective view diagrams showing another patterned disposable plastic cup 900a according to an exemplary embodiment of the invention. As shown in FIGS. 9A and 9B, the plastic cup 900a may comprise an exterior 905 having a swirl pattern (with two intermixed color layers) resulting from the above-described laminar flow agitation process. Cup 900a may also have a squared shape, for example, at the rim. According to an exemplary embodiment of the invention, the cup 900a may have a height of approximately 4″-6″, an interior rim diagonal of approximately 3.5″-4″, and an interior base circumference of approximately 2.5″-3″. The body of cup 900a (e.g., between the rim and the base) may have an average thickness of approximately 0.035″-0.050″, with an average thickness of each colored layer being approximately 0.015″. The swirl pattern on the exterior 905 of cup 900a may comprise a mixture of two or more distinct colors or shades of a same color (or to provide the effect of different shades of a same color, for example, Permanent Red 2B, and the like, mixed with Carbon Black or Titanium Dioxide White) having approximately proportional coverage on the exterior 905. According to embodiments of the invention, as reflected by the respective arrangements in FIGS. 7A-H, respective colors may have different surface coverage percentages on exterior 905. The respective layers (colors) forming the swirl pattern may be transparent, have the same or respective degrees of translucency, or opaque. According to an exemplary embodiment of the invention, cup 900a may comprise an opaque interior 910a having, for example, a white color (e.g., Titanium Dioxide), the opaque interior 910a providing a backdrop to the transparent/translucent layers forming the swirl pattern on the exterior 905. As an example, a resulting contrast range on exterior 905 may be between approximately 10% to 80%. Exterior 905 of cup 900a may have a shape transition—for example, from a squared rim to a circular base, or vice versa. It may be smooth, patterned with, say, one or more ridges, or may comprise one or more textures corresponding to additives for the respective color layers.

FIGS. 9C and 9D are perspective and top view diagrams illustrating another alternate patterned disposable plastic cup to the cup shown in FIGS. 9A and 9B according to an exemplary embodiment of the invention. As shown in FIGS. 9C and 9D, plastic cup 900b may comprise an exterior 905 having a swirl pattern resulting from the above-described laminar flow agitation process. According to an exemplary embodiment of the invention, cup 900b may be similarly dimensioned as cup 900a with a corresponding patterned exterior 905. However, cup 900b may comprise an interior 910b devoid of an opaque layer. In other words, a swirl pattern, which may correspond to the pattern on exterior 905 dependent upon the transparency and translucency of the respective swirl pattern layers, is visible on the interior 910b of the cup 900b, as shown in FIGS. 9C and 9D. As an example, a resulting contrast range on the exterior 905 may be between approximately 10% to 80%. Cup 900b may also have an average body thickness of approximately 0.040″ without the opaque interior layer.

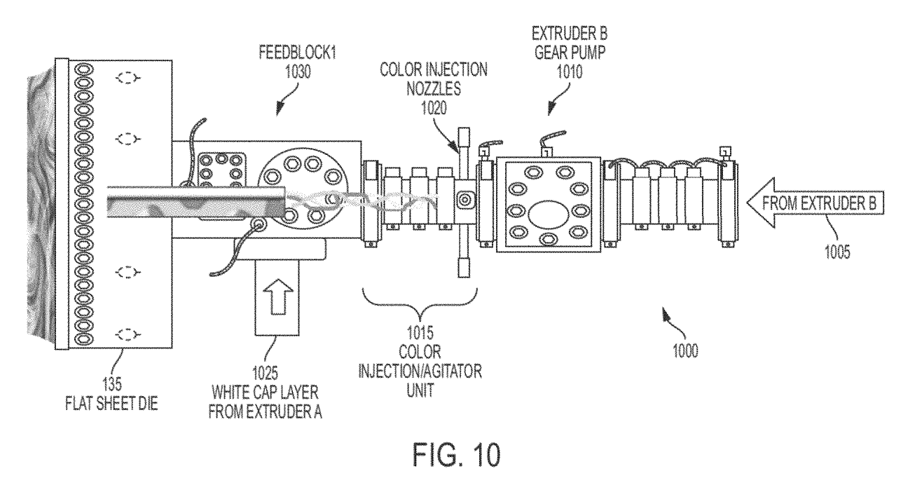

FIG. 10 is a schematic diagram illustrating an extrusion system 1000 incorporating a color injection and agitation device 1015 to impart an integrated pattern to a single use plastic container embodying exemplary features of the invention. As shown in FIG. 10, the extrusion system 1000 may receive a flow of material from an extruder 1005, similar to extruders in embodiments described above, with a gear pump 1010 (which may be driven by a gear pump motor) pumping the flow material downstream, eventually through a flat sheet die 135. In accordance with an exemplary embodiment of the invention, system 1000 may incorporate a color injection/agitator unit 1015 that incorporates one or more color injection nozzles 1020 for injecting liquid color to the flow material. The color injection/agitator unit 1015 preferably comprises multiple color injection nozzles 1020 for injecting different respective colors that can be mixed by an internal mixer to form various color patterns. Advantageously, the color injection/agitator unit 1015 would only require one extruder for the various color streams—instead of multiple extruders each devoted to a respective one of the color streams—and one additional extruder 1025 for a white cap layer, as shown in FIG. 10. Accordingly, the color injection/agitator unit 1015 only requires one feedblock 1030 for combining the unitary swirled color flow material with the white cap layer extruded from extruder 1025, thus eliminating the need for a second feedblock to combine multiple color extrusion flows for mixing.

Additionally, the liquid color injection technique illustrated in FIG. 10 results in reduced resin material usage for each single use container incorporating a color swirl pattern, requires lower operating temperatures for manufacturing the single use containers, and enables lower cycle times for manufacturing the single use containers. The liquid color injection technique also reduces colorant addition levels required for manufacturing the single use containers—0.5% to 1% for opaque colors and less for tints vs. 3% to 4% for most solid concentrates, for example, used to form the respective materials A, B, C, and D shown in FIGS. 7A-H. Collectively, these advantages further provide for reduced costs for manufacturing the single user containers.

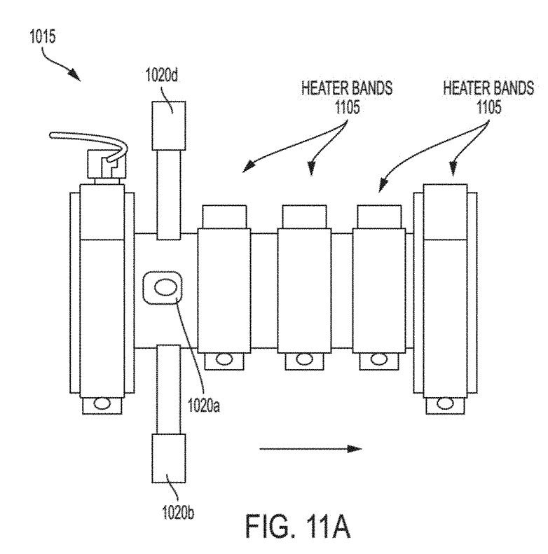

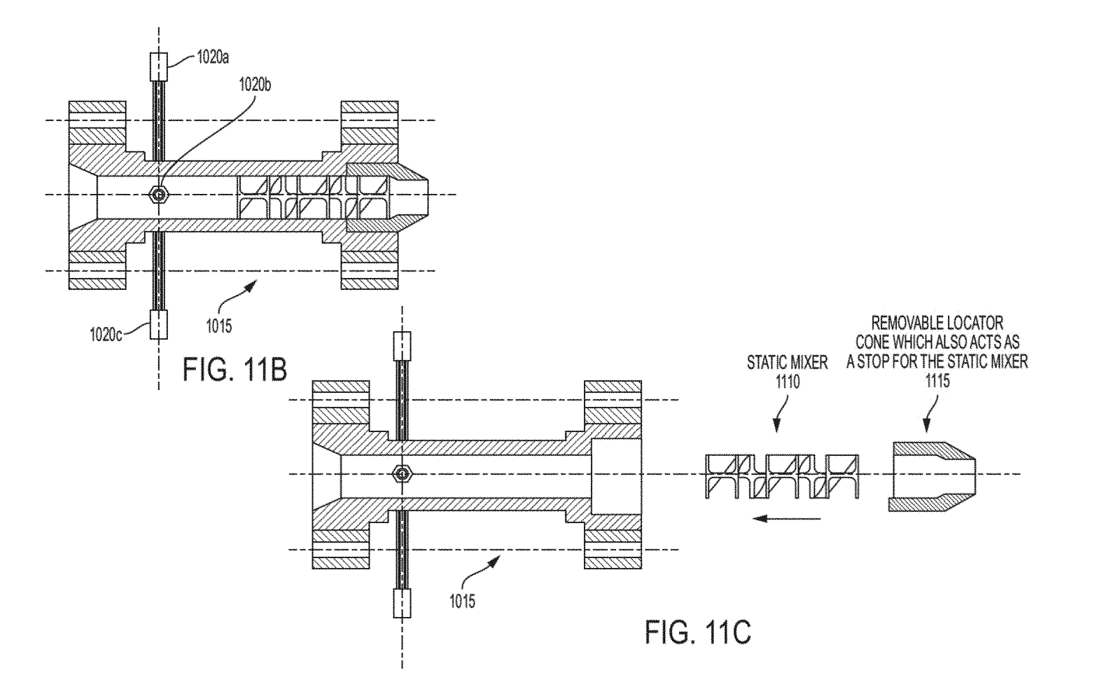

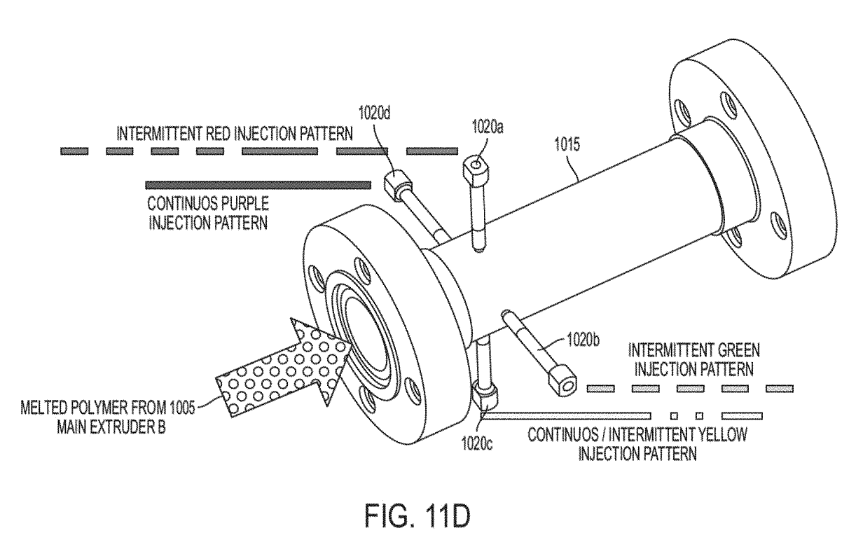

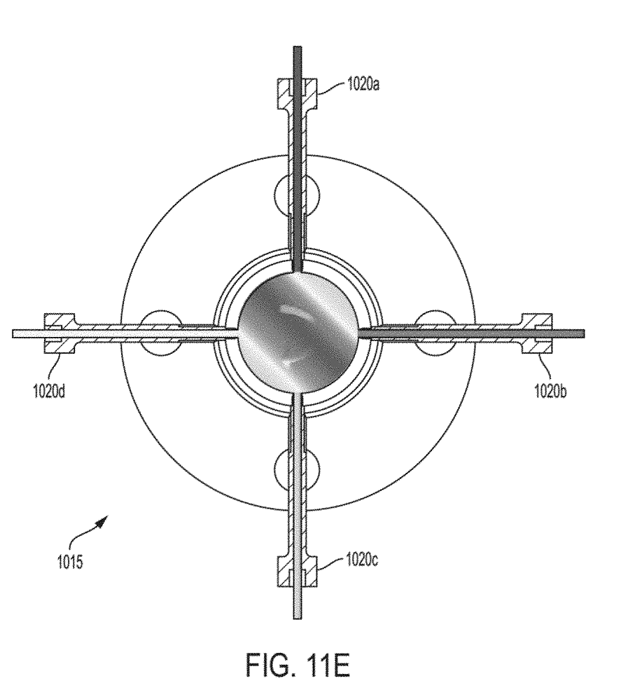

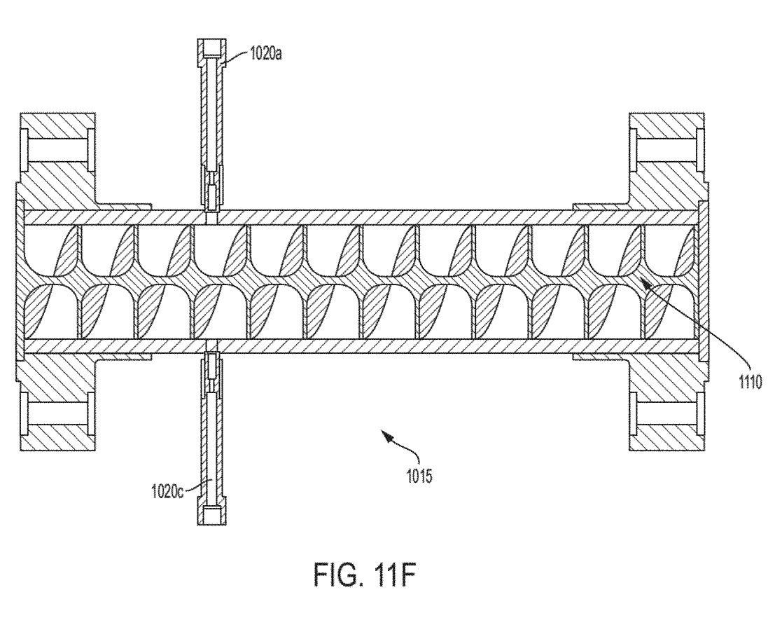

FIG. 11A is a plan view illustrating a color injection/agitator unit 1015 incorporating a plurality of optional heater bands 1105 downstream from nozzle(s) 1020 (e.g., 1020a, 1020b, and 1020d shown in FIG. 11A) for controlling the internal operating temperature of unit 1015 in mixing the liquid color injected via the injection nozzle(s) 1020 (e.g., 1020a, 1020b, and 1020d) to the flow of polymer material.

FIGS. 11B and 11C are cross-sectional and exploded views of a color injection/agitator unit 1015 according to an exemplary embodiment of the invention. As shown in FIGS. 11B and 11C, the color injection/agitator unit 1015 may incorporate a plurality of injection nozzles 1020a, 1020b, and 1020c (see also 1020d shown in FIG. 11D) that are disposed to inject respective liquid colors from directions that are orthogonal from one another. According to alternative embodiments of the invention, a different number of injection nozzles 1020 disposed at different relative positions may also be used for injecting the different colors. As further illustrated in FIGS. 11B and 11C, the color injection/agitator unit 1015 incorporates an internal static mixer 1110 downstream from the injection nozzles 1020a-d. The internal static mixer 1110 may be held in place with a removable stopper 1115 that includes a through hole for facilitating the flow of material mixed with injected color to feedblock 1030, as shown in FIG. 10, for combining with a white cap layer before being formed into a flat sheet for pressing into single use containers.

As illustrated in FIGS. 11B and 11C, and as described in further detail below, static mixer 1110 may incorporate plural respective surfaces—which may comprise planar, angled, and/or curved surfaces—at varying angles to a central axis of an internal channel of the color injection/agitator unit 1015—the central axis being parallel to a flow direction of the melted polymer flow material from the extruder that is, in turn, directed to the flat sheet die 135, as shown in FIG. 10. Accordingly, the flow material, in passing through the internal channel of the color injection/agitator unit 1015—may exert forces at varying vectors (directions and magnitudes) on the respective surfaces of the static mixer 1110, push the static mixer 1110 against stopper 1115, and cause the static mixer 1110 to rotate around an axis, which may be parallel to the central axis of the internal channel of the color injection/agitator unit 1015. The rotation of the static mixer 1110 may, in turn, cause the respective surfaces of the static mixer 1110 to direct, agitate, fold, disrupt, and/or intermix different portions of the flow material over, under, across, and/or into one another. As a result, different colors injected through the respective nozzles 1020a-d may be intermixed to form regular and/or irregular intertwining patterns in the flow material. Advantageously, the static mixer 1110 is directed by the flow material and, therefore, does not require separate additional power input to the system for operation. As illustrated in FIG. 11D, the flow of the respective colors injected through nozzles 1020a-d may be continuous or intermittent with varying flow and pause rates/durations to provide different color mixtures, proportions, and patterns in the flow material.

FIG. 11E is a cross-sectional view of the portion of the color injection/agitator unit 1015 incorporating the nozzles 1020a-d in accordance with an exemplary embodiment of the invention. As shown in FIG. 11E and as described above, nozzles 1020a-d may be arranged around a circumference of the color injection/agitator unit 1015 at regular intervals—e.g., adjacent nozzles being orthogonal to one another—to inject the respective colors to the flow material.

FIG. 11F is a side cross-sectional view of the color injection and agitation device 1015 according to an alternative embodiment of the invention. As shown in FIG. 11F, the color injection and agitation device 1015 may comprise a static mixer that, in contrast from FIGS. 11B and 11C, is inserted on an upstream side instead of a downstream side of the color injection and agitation device 1015. Advantageously, this embodiment eliminates the need for a stopper 1115 and possible durability issues related to its attachment to the color injection and agitation device 1015. According to an exemplary embodiment of the invention, the static mixer 1110 may extend beyond the color injection nozzles 1020a-d on the upstream side of the color injection and agitation device 1015. Accordingly, flow material may be agitated before and after color is injected.

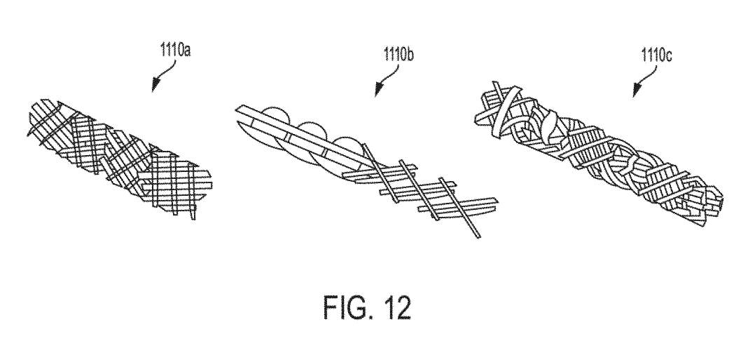

FIG. 12 illustrates examples of the static mixer 1110a, 1110b, and 1110c that may be incorporated in the color injection/agitator unit 1015 in the manner shown in FIGS. 11B, 11C, and 11D in accordance with exemplary embodiments of the invention. As shown in FIG. 12 and as described above, static mixer 1110a, 1110b, and 1110c may incorporate plural respective surfaces—which may comprise planar, angled, and/or curved surfaces—at varying angles and with one or more regular and/or irregular patterns to effectuate the color and flow material mixing. According to an exemplary embodiment of the invention, the length of the static mixer 1110 (1110a-c) may be selected in order to obtain a desirable pattern.

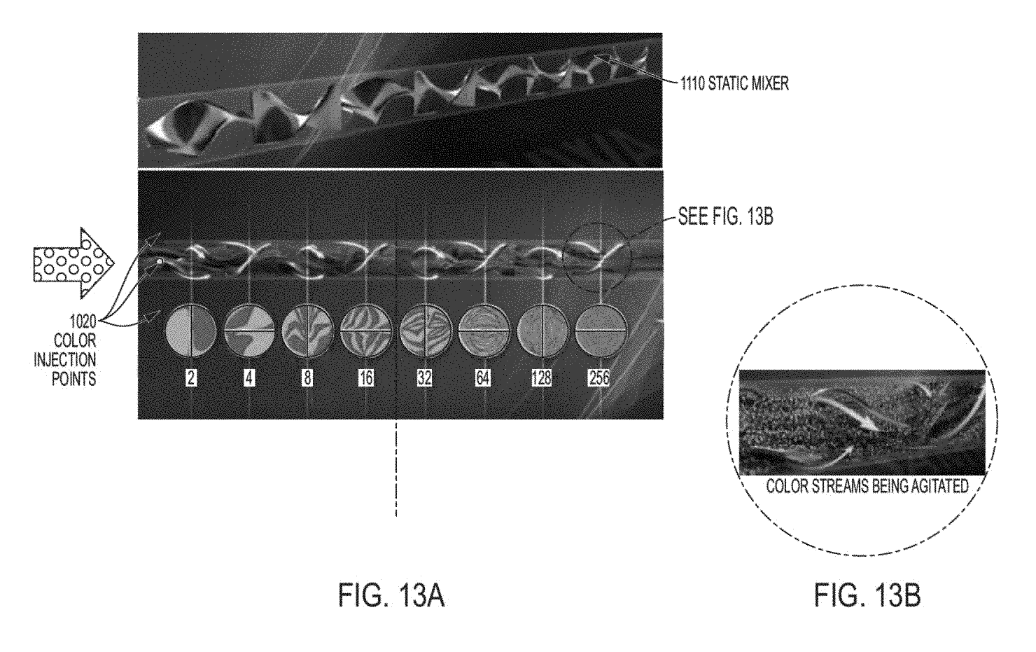

FIGS. 13A and 13B are cross-sectional diagrams of an internal flow channel of the color injection/agitator unit 1015 downstream from color injection nozzles 1020 (e.g., 1020a-d) with illustrations of respective patterns of the flow material resulting from using the static mixer 1110 (e.g., 1110a-c) at various lengths in the color injection/agitator unit 1015, showing an exponential increase in the interfolding of the layers of the flow over the length of the mixer. For illustrative purposes, FIG. 13A shows patterns resulting from two different colors being injected through respective nozzles 1020. As shown in FIG. 13A, using a static mixer 1110 with a shorter length (2-16) in the color injection/agitator unit 1015 results in patterns that are less intertwined and that incorporate larger continuous color portions than using a static mixer 1110 with a longer length (32-256).

“And/or” as used herein, for example, with option A and/or option B, encompasses the separate embodiments of (i) option A, (ii) option B, and (iii) option A plus option B. Where a numerical range is provided herein, it is understood that all numerical subsets of that range, and all the individual integers contained therein and one tenth portions thereof, are provided as part of the invention as individual embodiments.

Now that the preferred embodiments of the present invention have been shown and described in detail, various modifications and improvements thereon will become readily apparent to those skilled in the art. Accordingly, the spirit and scope of the present invention is to be construed broadly and not limited by the foregoing specification.

1. A single use container, comprising:
one or more first layers of a first polymer material having a first pigmentation, the first pigmentation comprising a pigmentation type selected from the group consisting of Phthalocynanine Green, Phthalocynanine Blue, Benzimidazolone Yellow or Orange, Alizarine Maroons, Titanium Dioxide White, Permanent Red 2B, and Carbon Black; and
one or more second layers of a second polymer material having a second pigmentation, the second pigmentation being different from the first pigmentation and comprising a pigmentation type selected from the group;
wherein at least one of the first layers and at least one of the second layers are intertwined with each other on one or more of an outer surface and an inner surface of the single use container.

2. The single use container of claim 1, wherein the first polymer material and the second polymer material comprise a same material selected from the group consisting of polypropylene, HIPS (High Impact Polystyrene), APET (Amorphous Polethylene Terephthalate), HDPE (High Density Polyethylene).

3. The single use container of claim 1, wherein the intertwined at least one first layer and at least one second layer form one or more isotropic pattern features on the one or more of the outer surface and the inner surface of the single use container.

4. The single user container of claim 3, wherein the intertwined at least one first layer and at least one second layer form a pseudo-random pattern on the one or more of the outer surface and the inner surface of the single use container.

5. The single use container of claim 1, further comprising a single color layer on the inner surface.

6. The single user container of claim 5, wherein the single color layer is an opaque white layer.

7. The single use container of claim 1, further comprising a base and one or more side walls.

8. The single use container of claim 7, wherein at least one of the one or more side walls has a thickness of about 0.05″ to 0.1″.

9. The single use container of claim 7, wherein the one or more side walls comprises a substantially cylindrical side wall.

10. The single use container of claim 7, wherein the at least one of the first layers and the at least one of the second layers overlap each other on one or more of an inner surface and an outer surface of the one or more side walls.

11. The single use container of claim 10, wherein the at least one of the first layers and the at least one of the second layers overlap each other to form one or more isotropic pattern features on the one or more of the inner surface and the outer surface of the one or more side walls.

12. The single use container of claim 10, wherein the at least one of the first layers and the at least one of the second layers overlap each other to form a pseudo-random pattern on the one or more of the inner surface and the outer surface of the one or more side walls.

13. The single use container of claim 7, wherein a single color layer is disposed on an inner surface of the one or more side walls.

14. The single use container of claim 1, wherein one or more of the first layers comprises a different respective characteristic from at least one of the second layers, the characteristic being selected from the group consisting of translucency, gloss, and surface texture.

15. A method for forming a single use container incorporating one or more pattern features on one or more of an outer surface and an inner surface, comprising:
extruding a first polymer material to form a first flow of the first polymer material;
injecting a plurality of pigments at respective locations to the first flow of the first polymer material;
agitating the first flow of the first polymer material with the injected plurality of pigments;
extruding the agitated flow of the first polymer material through a flat sheet die; and
molding the extruded first polymer material from the flat sheet die to a predetermined shape of the single use container.

16. The method of claim 15, wherein the extruded polymer material from the flat sheet die has a thickness less than 0.08″.

17. The method of claim 15, further comprising:
extruding a second polymer material to form a second flow of the second polymer material; and
combining the second flow of the second polymer material with the agitated flow of the first polymer material prior to the extruding through the flat sheet die.

18. The method of claim 17, wherein the second flow of the second polymer material comprises a single color.

19. The method of claim 17, wherein the injecting comprises one or more of continuous and intermittent injections of the respective pigments.

20. The method of claim 17, wherein the injecting comprises a plurality of different injection rates for the respective pigments.

21. The method of claim 17, wherein the agitating is performed by a static mixer.

22. The method of claim 17, further comprising agitating the first flow of the first polymer material prior to the injecting of the plurality of pigments.

23. A method for forming a single use container incorporating one or more pattern features with a plurality of pigments on one or more of an outer surface and an inner surface, comprising:
extruding a first polymer material to form one or more first laminar flows having a first pigmentation, the first pigmentation comprising a pigmentation type selected from the group consisting of Phthalocynanine Green, Phthalocynanine Blue, Benzimidazolone Yellow or Orange, Alizarine Maroons, Titanium Dioxide White, Permanent Red 2B, and Carbon Black;
extruding a second polymer material to form one or more second laminar flows having a second pigmentation, the second pigmentation being different from the first pigmentation and comprising a pigmentation type selected from the group
combining the one or more first laminar flows and the one or more second laminar flows;
agitating the combined flow of the first and second polymer material;
extruding the agitated flow of the first and second polymer material through a flat sheet die; and
molding the extruded first polymer material from the flat sheet die to a predetermined shape of the single use container.

24. The method of claim 23, further comprising:
extruding a third polymer material to form a third flow of the third polymer material; and
combining the third flow of the third polymer material with the agitated flow of the first and second polymer material prior to the extruding through the flat sheet die.

25. The method of claim 23, wherein the extruded first and second polymer material from the flat sheet die has a thickness greater than 0.08″.

26. The method of claim 25, wherein the third flow of the third polymer material comprises a single color.
